(19) United States
(12) Patent Application Publication
(10) Pub. No.: US 2024/0291038 A1
(43) Pub. Date: Aug. 29, 2024

(54) Electrolyte Solution for Lithium Secondary Battery and Lithium Secondary Battery Including the Same

(71) Applicants: SK On Co, Ltd., Seoul (KR); SK Innovation Co, Ltd., Seoul (KR)

(72) Inventors: Min Young Lee, Daejeon (KR); Min Woo Park, Daejeon (KR); Myoung Lae Kim, Daejeon (KR)

(21) Appl. No.: 18/437,786

(22) Filed: Feb. 9, 2024

(30) Foreign Application Priority Data
Feb. 13, 2023 (KR) 10-2023-0018832

(51) Int. Cl. H01M 10/0569; H01M 10/052; H01M 10/0567; H01M 10/0568

(52) U.S. Cl. CPC H01M 10/0569; H01M 10/052; H01M 10/0567; H01M 10/0568; H01M 2300/0042

(57) ABSTRACT

According to the present disclosure, an electrolyte solution for a lithium secondary battery and a lithium secondary battery including the electrolyte solution are provided. The electrolyte solution for a lithium secondary battery includes a lithium salt, an organic solvent including a linear carbonate-based compound represented by Chemical Formula 1, a linear ester-based compound represented by Chemical Formula 2, and a compound represented by Chemical Formula 3.

### CROSS REFERENCE TO RELATED APPLICATION

This application claims priority to Korean Patent Applications No. 10-2023-0018832 filed Feb. 13, 2023, the disclosure of which is hereby incorporated by reference by reference in its entirety.

### BACKGROUND OF THE INVENTION

### 1. Field of the Invention

The present disclosure of this patent document relates to an electrolyte solution and a lithium secondary battery including the same. More particularly, the present invention relates to an electrolyte solution including a lithium salt and an organic solvent, and a lithium secondary battery including the same.

### 2. Description of Related Art

A secondary battery which can be charged and discharged repeatedly has been widely employed as a power source of a mobile electronic device such as a camcorder, a mobile phone, a laptop computer, etc.

A lithium secondary battery is actively developed and applied among various types of secondary batteries due to high operational voltage and energy density, a high charging rate, a compact dimension, etc. Accordingly, the lithium secondary battery is also applied to a power source for an electric vehicle.

For example, the lithium secondary battery may include an electrode assembly including a cathode, an anode and a separation layer (separator), and an electrolyte solution immersing the electrode assembly. The lithium secondary battery may further include, e.g., a pouch-shaped exterior material accommodating the electrode assembly and the electrolyte solution.

As an application range of the lithium secondary batteries is expanded, enhanced life-span and higher capacity and operational stability are required. Accordingly, a lithium secondary battery that provides uniform power and capacity even during repeated charging and discharging is preferable.

However, power and capacity may be decreased due to surface damages of a nickel-based lithium metal oxide used as a cathode active material, and side reactions between the nickel-based lithium metal oxide and the electrolyte solution may occur to degrade rapid charge properties.

### SUMMARY OF THE INVENTION

According to an aspect of the present disclosures, there is provided an electrolyte solution for a lithium secondary battery providing improved electrochemical performance and operational reliability.

According to an aspect of the present invention, there is provided a lithium secondary battery having improved electrochemical performance and operational reliability.

An electrolyte solution for a lithium secondary battery according to embodiments of the present disclosure includes a lithium salt, an organic solvent including a linear carbonate-based compound represented by Chemical Formula 1 and a linear ester-based compound represented by Chemical Formula 2, and a compound represented by Chemical Formula 3.

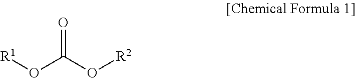

In Chemical Formula 1, R¹ and R² are each independently a C1-C6 alkyl group, and at least one of R¹ and R² is a methyl group.

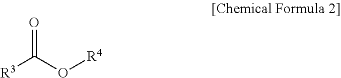

In Chemical Formula 2, R³ is a C1-C6 alkyl group, and R⁴ is a C3-C10 alkyl group.

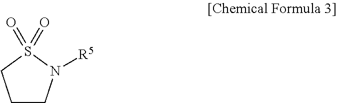

In Chemical Formula 3, R⁵ is a C1-C10 alkyl group, a C2-C10 alkenyl group, or a C2-C10 alkynyl group.

In some embodiments, in Chemical Formula 1, R¹ and R² may be each independently a C1-C3 alkyl group, and at least one of R¹ and R² is a methyl group.

In some embodiments, in Chemical Formula 2, R³ may be a C1-C3 alkyl group, and R⁴ may be a C3-C6 alkyl group.

In some embodiments, the organic solvent may further include a cyclic carbonate-based compound represented by Chemical Formula 4.

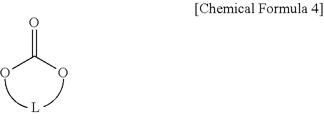

In Chemical Formula 4, L may be a C2-C5 alkylene group or a C2-C5 alkenylene group.

In some embodiments, the linear ester-based compound represented by Chemical Formula 2 is contained in an amount from 10 vol % to 30 vol % based on a total volume of the organic solvent.

In some embodiments, in Chemical Formula 3, R⁵ may be a C2-C10 alkynyl group.

In some embodiments, a content of the compound represented by Chemical Formula 3 may be in a range from 0.1 wt % to 10 wt % based on a total weight of the electrolyte solution. In some embodiments, the lithium salt may include LiPF₆.

In some embodiments, the lithium salt may further include a sulfonylimide-based lithium salt represented by Chemical Formula 5.

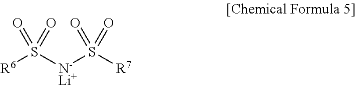

In Chemical Formula 5, R⁶ and R⁷ may be each independently fluorine or a C1-C6 fluorine-containing alkyl group.

In some embodiments, a ratio of a molar concentration of LiPF₆ relative to a molar concentration of the sulfonylimide-based lithium salt represented by Chemical Formula 5 in the electrolyte solution may be in a range from 1 to 2.

In some embodiments, the electrolyte solution for a lithium secondary battery may further include an auxiliary additive including at least one selected from the group consisting of a fluorine-containing carbonate-based compound, a sultone-based compound, a cyclic sulfate-based compound and a fluorine-containing lithium phosphate-based compound.

In some embodiments, a weight ratio of the auxiliary additive relative to the compound represented by Chemical Formula 3 in the electrolyte solution may be in a range from 0.5 to 10.

A lithium secondary battery includes a cathode, an anode facing the cathode, and the electrolyte solution for a lithium secondary battery according to embodiments as describe above.

An electrolyte solution for a lithium secondary battery according to example embodiments may include an organic solvent and an additive according to embodiments of the present disclosure to provide a lithium secondary battery having reduced initial resistance and improved rapid charging performance.

A lithium secondary battery according to example embodiments including the electrolyte solution may have reduced initial resistance, and improved life-span, capacity retention and rapid charging performance.

### BRIEF DESCRIPTION OF THE DRAWINGS

FIGS. 1 and 2 are a schematic plan view and a schematic cross-sectional view, respectively, illustrating a lithium secondary battery in accordance with example embodiments.

### DESCRIPTION OF THE INVENTION

According to example embodiments of the present disclosure, an electrolyte solution for a lithium secondary battery including a lithium salt, an organic solvent that may be represented by a specific chemical formula and a compound that may be represented by a specific formula may be provided. Additionally, a lithium secondary battery including the electrolyte solution may be provided.

In the present specification, the term “Ca-Cb” refers that the number of carbon (C) atoms is from a to b.

### <Electrolyte Solution for Lithium Secondary Battery>

An electrolyte solution for a lithium secondary battery according to embodiments of the present disclosures includes a lithium salt, an organic solvent and an additive.

The lithium salt may serve as an electrolyte. For example, the lithium salt may be represented by Li⁺X⁻.

For example, an anion (X⁻) of the lithium salt may include F⁻, Cl⁻, Br⁻, I⁻, NO₃⁻, N(CN)₂⁻, BF₄⁻, ClO₄⁻, PF₆⁻, SbF₆⁻, AsF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc. They may be used alone or in a combination of two or more therefrom.

In some embodiments, the lithium salt may include LiPF₆. Accordingly, a rapid charging capacity of the lithium secondary battery may be improved, and an initial resistance may be reduced.

In some examples, the lithium salt may include a sulfonyl imide-based lithium salt represented by Chemical Formula 5 below. Accordingly, the rapid charging capacity of the lithium secondary battery may be improved, and the initial resistance may be reduced.

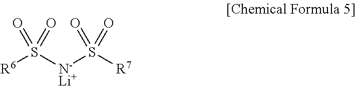

In Chemical Formula 5, R⁶ and R⁷ may each independently be a fluorine or a C1-C6 fluorine-containing alkyl group.

For example, when the number of carbon atoms of the alkyl group is 3 or more, the alkyl group may have a linear or branched structure.

In some embodiments, the lithium salt may include LiPF₆ and the sulfonyl imide-based lithium salt represented by Chemical Formula 5. For example, the lithium salt may include both LiPF₆ and LiFSI.

The lithium salt may be used together with an organic solvent including a linear carbonate-based compound represented by Chemical Formula 1 and a linear ester (carboxylate)-based compound represented by Chemical Formula 2, and a compound represented by Chemical Formula 3 as will be described later. Accordingly, the rapid charging performance of the lithium secondary battery may be further improved, and the initial resistance may be further reduced.

In some embodiments, a ratio of a molar concentration of LiPF₆ relative to a molar concentration of the sulfonyl imide-based lithium salt represented by Chemical Formula 5 may be in a range from 0.5 to 3, from 0.7 to 2.5, from 1 to 2.5, or from 1.4 to 2.4. In the above range, a rapid charging life-span of the lithium secondary battery may be improved.

In some embodiments, the lithium salt may be included in a concentration of 0.01 to 5 M, from 0.01 to 3 M, or from 0.01 to 2 M with respect to the organic solvent. In the above concentration range, transfer of lithium ions and/or electrons may be promoted during charging and discharging the lithium secondary battery.

The organic solvent may include, e.g., an organic compound having sufficient solubility for the above-described lithium salt, the additive and having substantially no reactivity in the battery. In some embodiments, the organic solvent may be a non-aqueous organic solvent.

In example embodiments, the organic solvent may include a linear carbonate-based solvent represented by Chemical Formula 1 and a linear ester-based compound represented by Chemical Formula 2.

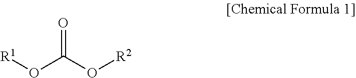

In Chemical Formula 1, R¹ and R² may each independently be a C1-C6 alkyl group, and at least one of R¹ and R² may be a methyl group.

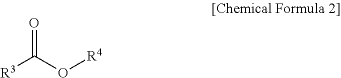

In Chemical Formula 2, R³ may be a C1-C6 alkyl group, and R⁴ may be a C3-C10 alkyl group.

For example, if the number of carbon atoms of the alkyl group in R¹ to R⁴ is 3 or more, the alkyl group may have a linear or branched structure.

The organic solvent including the linear carbonate-based compound represented by Chemical Formula 1 and the linear ester-based compound represented by Chemical Formula 2 may be used together with the compound represented by Chemical Formula 3, so that a fast rapid rate and a rapid charge capacity retention may be further improved.

In some embodiments, R¹ and R² of the linear carbonate-based compound represented by Chemical Formula 1 may each independently be a C1-C3 alkyl group, and at least one of R¹ and R² may be a methyl group. For example, when the number of carbon atoms of the alkyl group is 3, the alkyl group may have a linear or branched structure.

For example, the linear carbonate-based compound represented by Formula 1 may include dimethyl carbonate (DMC), ethyl methyl carbonate (EMC), etc. For example, the linear carbonate-based compound represented by Chemical Formula 1 may not include diethyl carbonate (DEC).

At least one of R¹ and R² of the linear carbonate-based compound represented by Chemical Formula 1 may be a methyl group, so that the initial resistance of the lithium secondary battery may be reduced and the rapid charge rate may be enhanced.

In some embodiments, R³ of the linear ester (carboxylate)-based compound represented by Chemical Formula 2 may be a C1-C3 alkyl group, and R⁴ may be a C3-C6 alkyl group. For example, when the number of carbon atoms in the alkyl group is 3 or more, the alkyl group may have a linear or branched structure.

For example, the ester (carboxylate)-based compound may include n-propyl acetate (n-PA), 1,1-dimethyl ethyl acetate (DMEA), propyl propionate (PP), etc. For example, the ester (carboxylate)-based compound may not include methyl propionate (MP) and ethyl propionate (EP).

When the number of carbon atoms of R⁴ in the linear ester (carboxylate)-based compound represented by Chemical Formula 2 is 3 or more, the initial resistance of the lithium secondary battery may be reduced, and the rapid charging rate may be enhanced.

In some embodiments, the linear ester (carboxylate)-based compound may be included in an amount from 10 volume percent (vol %) to 30 vol %, from 15 vol % to 30 vol %, or from 20 vol % to 30 vol % based on a total volume of the organic solvent. In the above volume range, the rapid charging rate of the lithium secondary battery may be enhanced.

In some embodiments, the organic solvent may further include a cyclic carbonate-based compound represented by Chemical Formula 4.

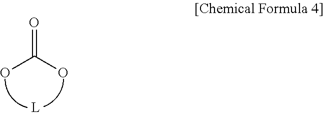

In Chemical Formula 4, L may be a C2-C5 alkylene group or a C2-C5 alkenylene group.

For example, when the number of carbon atoms of the alkylene group and the alkenylene group is 3 or more, the alkylene group and the alkenylene group may each independently have a linear structure or a branched structure.

For example, the cyclic carbonate-based solvent may include ethylene carbonate (EC), propylene carbonate (PC), butylene carbonate, etc.

Accordingly, the life-span properties (e.g., a capacity retention and a capacity recovery ratio) of the lithium secondary battery may be further improved.

In some embodiments, the organic solvent may further include an ether-based solvent, a ketone-based solvent, an alcohol-based solvent, an aprotic solvent, etc.

For example, the ether-based solvent may include dibutyl ether, tetraethylene glycol dimethyl ether (TEGDME), diethylene glycol dimethyl ether (DEGDME), dimethoxyethane, tetrahydrofuran (THF), 2-methyltetrahydrofuran, etc.

For example, the ketone-based solvent may include cyclohexanone.

For example, the alcohol-based solvent may include ethyl alcohol, isopropyl alcohol, etc.

For example, the aprotic solvent may include a nitrile-based solvent, an amide-based solvent (e.g., dimethylformamide), a dioxolane-based solvent (e.g., 1,3-dioxolane), a sulfolane-based solvent, etc.

In example embodiments, the electrolyte solution for a lithium secondary battery may include a compound represented by Chemical Formula 3 below. For example, the compound represented by Chemical Formula 3 may be included as an additive.

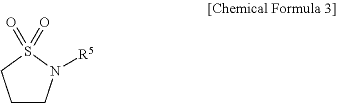

In Chemical Formula 3, R⁵ may be a C1-C10 alkyl group, a C2-C10 alkenyl group, or a C2-C10 alkynyl group.

For example, when the alkyl group, the alkenyl group and the alkynyl group have 3 or more carbon atoms, the alkyl group, the alkenyl group and the alkynyl group may each independently have a linear or branched structure.

In some embodiments, R⁵ may be a C2-C10 alkynyl group. For example, the compound represented by Chemical Formula 3 may include a compound represented by Chemical Formula 3-1.

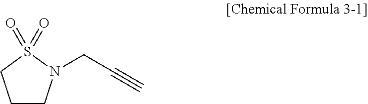

In this case, the lithium secondary battery may have more reduced initial resistance and greater capacity retention.

In some embodiments, a content of the additive may be in a range from 0.1 wt % to 10 wt %, from 0.1 wt % to 7 wt %, from 0.1 wt % to 5 wt %, or from 0.3 wt % to 5 wt %, or from 0.3 wt % to 2 wt % based on the total weight of the electrolyte solution. Within the above content range, the rapid charging performance of a lithium secondary battery may be further improved.

In example embodiments, the electrolyte solution may further include an auxiliary additive to further improve the performance (e.g., life-span properties) of the lithium secondary battery.

The auxiliary additive may include a fluorine-containing carbonate-based compound, a sultone-based compound, a cyclic sulfate-based compound, a fluorine-containing lithium phosphate-based compound, etc.

In some embodiments, the fluorine-containing carbonate-based compound above may include a fluorine atom bonded to at least one carbon atom in a carbonate-based compound structure. In one embodiment, a substituent (e.g., —CF₃) containing a fluorine atom may be bonded to at least one carbon atom in the carbonate-based compound structure. For example, the fluorine-containing carbonate-based compound may include a fluorine atom or a fluorine-substituted alkyl group bonded to at least one carbon atom in the carbonate-based compound structure.

In some embodiments, the fluorine-containing carbonate-based compound may be a cyclic carbonate-based compound having a cyclic structure. For example, the fluorine-containing carbonate-based compound may have a 5-7 membered cyclic structure.

For example, the fluorine-containing cyclic carbonate-based compound may include fluoroethylene carbonate (FEC), etc.

In some embodiments, the sultone-based compound may include an alkyl sultone-based compound or an alkenyl sultone-based compound.

In some embodiments, the sultone-based compound may include the alkyl sultone-based compound and the alkenyl sultone-based compound together.

For example, the sultone-based compound may include the alkyl sultone-based compound such as 1,3-propane sultone (PS) and 1,4-butane sultone.

For example, the sultone-based compound may not contain 1,3-propene sultone (PRS).

In the cyclic sulfate-based compound, at least one atom of a sulfate group may be positioned in a ring. For example, the cyclic sulfate-based compound may have a 5-7 membered cyclic structure.

For example, the cyclic sulfate-based compound may include ethylene sulfate (ESA), methyl ethylene sulfate, ethyl ethylene sulfate, 4,5-dimethyl ethylene sulfate, 4,5-diethyl ethylene sulfate, propylene sulfate, 4,5-dimethyl propylene sulfate, 4,5-diethyl propylene sulfate, 4,6-dimethyl propylene sulfate, 4,6-dimethyl propylene sulfate, 1,3-butylene glycol sulfate, etc.

In some embodiments, a fluorine atom or a fluorine-containing alkyl group (e.g., —CF₃) may be bonded to a phosphorus atom of the fluorine-containing lithium phosphate-based compound.

For example, the fluorine-containing lithium phosphate-based compound may include lithium difluorophosphate (LiPO₂F₂), lithium tetrafluorooxalate phosphate, lithium difluoro(bisoxalato)phosphate, etc.

In some embodiments, a ratio of a weight of the auxiliary additive relative to a weight of the additive in the electrolyte solution may be in a range from 0.5 to 10, from 1 to 5, from 1.25 to 4.75, from 1.5 to 4.5, or from 1.75 to 3.5. Accordingly, the capacity retention and the capacity recovery ratio of the lithium secondary battery may be further improved.

### Lithium Secondary Battery

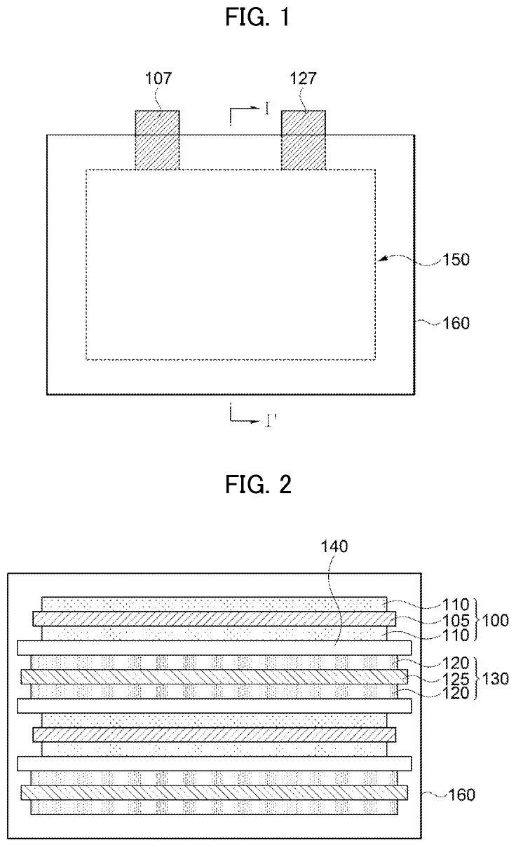

FIGS. 1 and 2 are a schematic plan view and a schematic cross-sectional view, respectively, illustrating a lithium secondary battery in accordance with exemplary embodiments. FIG. 2 is cross-sectional view taken along a line I-I′ of FIG. 1.

Referring to FIGS. 1 and 2, a lithium secondary battery may a cathode 100 and an anode 130.

The cathode 100 may include a cathode current collector 105 and a cathode active material layer 110 on the cathode current collector 105. For example, the cathode active material layer 110 may be formed on a single surface or both surfaces of the cathode current collector 105.

For example, the cathode active material layer 110 may include a cathode active material, a cathode binder, and a conductive material.

For example, the cathode active material, the cathode binder, the conductive material, a dispersion medium, etc., may be mixed and stirred to prepare a cathode slurry. The cathode slurry may be coated, dried and pressed to form the cathode 100.

For example, the cathode current collector 105 may include stainless steel, nickel, aluminum, titanium, copper, or an alloy thereof, and may include preferably aluminum or aluminum alloy.

The cathode active material may be a material capable of reversibly intercalating and de-intercalating lithium ions. For example, the cathode active material above may include a lithium metal oxide containing a metal element such as nickel, cobalt, manganese, aluminum, etc.

In some embodiments, the cathode active material may include lithium metal oxide particles including nickel.

In some examples, the lithium metal oxide particle may contain 80 mol % or more of nickel based on the total number of moles of all elements excluding lithium and oxygen. In this case, the lithium secondary battery having a high capacity may be implemented.

In some embodiments, the lithium metal oxide particle may include nickel in an amount of 83 mol % or more, 85 mol % or more, 90 mol % or more, or 95 mol % or more, based on the total number of moles of all elements excluding lithium and oxygen.

In some examples, the lithium metal oxide particle may further include at least one of cobalt and manganese. In this case, the lithium secondary battery having more improved power properties and penetration stability may be implemented.

In some embodiments, the lithium metal oxide particle may be represented by Chemical Formula 6.

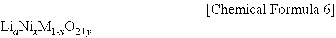

In Chemical Formula 6, M may include at least one of Co, Mn, Al, Zr, Ti, Cr, B, Mg, Ba, Si, Y, W, Sr, Na, Ca, Hf, V, Nb, Ta, Mo, Fe, Cu, Ag, Zn, Ga, C, and Sn.

In Chemical Formula 6, 0.9≤a≤1.2, 0.5≤x≤0.99, and −0.1≤y≤0.1.

In one embodiment, the lithium metal oxide particle may further include a doping element. For example, the doping element may include at least one of Al, Ti, Ba, Zr, Si, B, Mg, P, Sr, W, and La. In this case, the lithium secondary battery having more improved life-span properties may be implemented.

In one embodiment, the lithium metal oxide particles may further include a coating element. For example, the coating element may include at least one of Al, Ti, Ba, Zr, Si, B, Mg, P, Sr, W and La. In this case, the lithium secondary battery having more improved life-span properties may be implemented.

For example, the cathode binder may include an organic binder such as polyvinylidene fluoride (PVDF), polyvinylidene fluoride-hexafluoropropylene copolymer (PVDF-co-HFP), polyacrylonitrile, polymethylmethacrylate; and an aqueous binder such as styrene-butadiene rubber (SBR). For example, the cathode binder may be used together with a thickener such as carboxymethyl cellulose (CMC).

For example, the conductive material may include a carbon-based conductive material such as graphite, carbon black, graphene and carbon nanotube; and a metal-based conductive material such as tin, tin oxide, titanium oxide, a perovskite material such as LaSrCoO₃ and LaSrMnO₃, etc.

The anode 130 may include an anode current collector 125 and an anode active material layer 120 formed on the anode current collector 125. For example, the anode active material layer 120 may be formed on a single surface or both surfaces of the anode current collector 125.

The anode active material layer 120 includes an anode active material, and may further include an anode binder and a conductive material.

For example, an anode slurry may be prepared by mixing and stirring the anode active material, the anode binder, the conductive material, a solvent, etc. The anode slurry above may be coated, dried and pressed on the anode current collector 125 to prepare the anode 130.

For example, the anode current collector 125 may include gold, stainless steel, nickel, aluminum, titanium, copper or an alloy thereof, and preferably may include copper or a copper alloy.

For example, the anode active material above may include a material capable of intercalating and de-intercalating lithium ions. For example, the anode active material above may include a lithium alloy, a carbon-based material, a silicon-based material, etc.

For example, the lithium alloy may include a metal element such as aluminum, zinc, bismuth, cadmium, antimony, silicon, lead, tin, gallium, indium, etc.

For example, the carbon-based active material may include a crystalline carbon, an amorphous carbon, a carbon composite, a carbon fiber, etc.

For example, the amorphous carbon may include hard carbon, coke, mesocarbon microbeads (MCMB) fired at 1,500° C. or less, mesophase pitch-based carbon fiber (MPCF), etc.

For example, the crystalline carbon may include natural graphite, artificial graphite, graphitized coke, graphitized MCMB, graphitized MPCF, etc.

For example, the anode active material may include the silicon-based active material. For example, the silicon-based active material may include Si, SiOx (0<x<2), a silicon-carbon composite material (Si/C), SiO/C, Si-Metal, etc. In this case, the lithium secondary battery having higher capacity may be implemented.

For example, if the anode active material includes the silicon-based active material, a battery thickness may be increased during repeated charging and discharging. The lithium secondary battery according to embodiments of the present disclosure may include the above-described electrolyte solution to suppress or reduce the increase of the battery thickness.

In some embodiments, a content of a silicon atom in the anode active material may be in a range from 1 wt % to 20 wt %, from 1 wt % to 15 wt %, or from 1 wt % to 10 wt %.

The anode binder and the anode conductive material may include substantially the same as or similar to the cathode binder and the cathode conductive material. For example, the anode binder may include an aqueous binder such as styrene-butadiene rubber (SBR). The anode binder may be used together with a thickener such as carboxymethyl cellulose (CMC).

The electrolyte solution according to embodiments of the preset disclosure may form an electrode-electrolyte interface having high stability on an electrode surface. Accordingly, a side reaction between the electrode active material (e.g., the lithium metal oxide, the carbon-based material, the silicon-based material, etc.) and the electrolyte solution may be effectively suppressed.

In some embodiments, an area of the anode 130 may be larger than an area of the cathode 100. Accordingly, lithium ions generated from the cathode 100 may be easily transferred to the anode 130 without being precipitated.

For example, the cathode 100 and the anode 130 may be alternately and repeatedly arranged to form an electrode assembly 150.

In some embodiments, a separator 140 may be interposed between the cathode 100 and the anode 130. For example, the electrode assembly 150 may be formed by winding, stacking, zigzag-folding, etc., of the separator 140.

The separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separator 140 may also include a non-woven fabric formed from a glass fiber with a high melting point, a polyethylene terephthalate fiber, or the like.

The lithium secondary battery according to example embodiments may include a cathode lead 107 connected to the cathode 100 to protrude to an outside of a case 160, and an anode lead 127 connected to the anode 130 to protrude to the outside of the case 160.

For example, the cathode lead 107 may be electrically connected to the cathode current collector 105. The anode lead 127 may be electrically connected to the anode current collector 125.

The cathode current collector 105 may include a protrusion (a cathode tab, not illustrated) at one side thereof. The cathode active material layer 110 may not be formed on the cathode tab. The cathode tab 106 may be integral with the cathode current collector 105 or may be connected to the cathode current collector 105 by, e.g., welding. The cathode current collector 105 and the cathode lead 107 may be electrically connected via the cathode tab.

The anode current collector 125 may include a protrusion (an anode tab, not illustrated) at one side thereof. The anode active material layer 120 may not be formed on the anode tab. The anode tab 126 may be integral with the anode current collector 125 or may be connected to the anode current collector 125 by, e.g., welding. The anode electrode current collector 125 and the anode lead 127 may be electrically connected via the anode tab.

The electrode assembly 150 may include a plurality of the cathodes and a plurality of the anodes. For example, the cathodes and the anodes may be alternately disposed, and the separator may be interposed between the cathode and the anode. Each of the plurality of the cathodes may include the cathode tab. Each of the plurality of the anodes may include the anode tab.

For example, the cathode tabs (or the anode tabs) may be stacked, pressed and welded to form a cathode tab stack (or an anode tab stack). The cathode tab stack may be electrically connected to the cathode lead 107. The anode tab stack may be electrically connected to the anode lead 127.

The electrode assembly 150 may be accommodated together with the electrolyte solution according to the above-described embodiments in a case 160 to form the lithium secondary battery.

The lithium secondary battery may be fabricated into a cylindrical shape using a can, a prismatic shape, a pouch shape, a coin shape, etc.

Hereinafter, specific examples and comparative examples are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

### (1) Preparation of Electrolyte Solution for Lithium Secondary Battery

LiPF₆ solutions and mixed solutions of LiPF₆ and LiFSI having concentrations of Table 1 were prepared using mixed solvents of components shown in Table 1 below.

Based on a total weight of the electrolyte solution, an isothiazolidine-based additive and an auxiliary additive were added and mixed in the LiPF₆ solution (or the mixed solution of LiPF₆ and LiFSI) by the content (wt %) shown in Table 1 below to prepare electrolyte solutions of Examples and Comparative Examples.

### (2) Fabrication of Lithium Secondary Battery

Li[Ni_{0.8}Co_{0.1}Mn_{0.1}]O₂, carbon black and polyvinylidene fluoride (PVDF) were dispersed in N-methyl pyrrolidone (NMP) in a weight ratio of 98:1:1 to prepare a cathode slurry.

The cathode slurry was uniformly coated on a region of an aluminum foil having a protrusion (cathode tab) except for the protrusion, and dried and pressed to prepare a cathode.

An anode active material including Si/C and graphite mixed in a weight ratio of 15:85, styrene-butadiene rubber (SBR), and carboxymethyl cellulose (CMC) were dispersed in water by a weight ratio of 97:1:2 to prepare an anode slurry.

The anode slurry was uniformly coated on a region of a copper foil having a protrusion (anode tab) except for the protrusion, and dried and pressed to prepare an anode. An electrode assembly was formed by interposing a polyethylene separator (thickness: 13 μm) between the cathode and the anode. A cathode lead and an anode lead were welded and connected to the cathode tab and the anode tab, respectively.

The electrode assembly was accommodated in a pouch so that some portions of the cathode lead and the anode lead were exposed to an outside, and three sides were sealed except for an electrolyte injection side.

The electrolyte solution prepared in the above (1) was injected into the pouch, and the electrolyte injection side was also sealed to prepare a lithium secondary battery sample.

TABLE 1

| | components | | | | | | | | |
|---|---|---|---|---|---|---|---|---|---|
| | and volume | | | | | | | | |
| | ratios of | lithium salt | | isothiazolidine- | auxiliary additive | | | | |
| | organic | LiPF₆ | LiFSI | based additive | (C) | | | | |
| | solvent (A) | (M) | (M) | (B) | LiPO₂F₂ | FEC | PS | PRS | ESA |
| Example 1 | EC:EMC:PP | 1.0 | — | 0.3 | 1.0 | 1.0 | 0.5 | — | 0.5 |
| | 25:45:30 | | | | | | | | |
| Example 2 | EC:EMC:PP | 0.6 | 0.4 | 0.3 | 1.0 | 1.0 | 0.5 | — | 0.5 |
| | 25:45:30 | | | | | | | | |
| Example 3 | EC:EMC:PP | 0.6 | 0.4 | 0.3 | 1.0 | 1.0 | 0.5 | — | 0.5 |
| | 25:55:20 | | | | | | | | |
| Example 4 | EC:EMC:PP | 0.7 | 0.3 | 0.3 | 1.0 | 1.0 | 0.5 | — | 0.5 |
| | 25:45:30 | | | | | | | | |
| Comparative | EC:EMC:PP | 1.0 | — | — | 1.0 | 1.0 | 0.5 | 0.3 | 0.5 |
| Example 1 | 25:45:30 | | | | | | | | |
| Comparative | EC:EMC:PP | 0.6 | 0.4 | — | 1.0 | 1.0 | 0.5 | 0.3 | 0.5 |
| Example 2 | 25:45:30 | | | | | | | | |
| Comparative | EC:DEC:PP | 0.6 | 0.4 | 0.3 | 1.0 | 1.0 | 0.5 | — | 0.5 |
| Example 3 | 25:45:30 | | | | | | | | |
| Comparative | EC:EMC:MP | 0.6 | 0.4 | 0.3 | 1.0 | 1.0 | 0.5 | — | 0.5 |
| Example 4 | 25:45:30 | | | | | | | | |
| Comparative | EC:EMC:EP | 0.6 | 0.4 | 0.3 | 1.0 | 1.0 | 0.5 | — | 0.5 |
| Example 5 | 25:45:30 | | | | | | | | |

The components listed in Table 1 are as follows.

### Organic Solvent (A)

EC: ethylene carbonate
EMC: ethyl methyl carbonate
DEC: diethyl carbonate
PP: propyl propionate
MP: methyl propionate
EP: ethyl propionate

### Isothiazolidine-Based Additive (B):

a compound represented by Chemical Formula 3-1 below

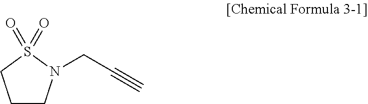

### Auxiliary Additive (C)

LiPO₂F₂: lithium difluorophosphate
FEC: fluoroethylene carbonate
PS: 1,3-propane sultone
PRS: 1,3-propen sultone
ESA: ethylene sulfate

### Experimental Example

### 1. Evaluation on Initial Performance

### (1) Evaluation on Initial Capacity

The lithium secondary batteries of Examples and Comparative Examples were repeatedly charged (CC-CV 0.5C 4.2V 0.05C CUT-OFF) and discharged (CC 0.5C 3.0V CUT-OFF) at room temperature (25° C.) three times to measure a discharge capacity at the 3rd cycle.

### (2) Evaluate on Internal Resistance (C_DCIR and D_DCIR)

The lithium secondary batteries of Examples and Comparative Examples were charged to a state of charge (SOC) of 60%.

At the point of SOC 60%, C-rate was changed to 0.2C, 0.5C, 1.0C, 1.5C, 2.0C and 2.5C, and discharged and supplementarily charged for 10 seconds at each rate. Voltages during the discharge and supplementary charge was plotted, and a slope therefrom was adopted as DCIR.

The measured D_DCIR and C_DCIR values are shown in Table 2.

### 2. Evaluation on Rapid Charge Performance

### (1) Evaluation on Rapid Charge Rate

The lithium secondary batteries of Examples and Comparative Examples were charged at 0.33C to an SOC 8%. When the lithium secondary battery was charged at 2C, a time required to charge to SOC 80% was measured.

### (2) Evaluation on Rapid Charge Retention

The lithium secondary batteries of Examples and Comparative Examples were charged at 0.33C to SOC 8%, charged in a stepwise manner at 2.5C-2.25C-2C-1.75C-1.5C-1.0C in a section of SOC 8-80%, charged at 0.33C (4.3V, 0.05C CUT-OFF) in a section of SOC 80-100%, and then discharged (0.33C 2.7V CUT-OFF).

The charge and discharge were repeatedly performed 100 times to measure a discharge capacity at the 1st cycle Q₁ and a discharge capacity at the 100th cycle Q₁₀₀.

A rapid charging capacity retention was calculated as follows.

Rapid charge capacity retention(%)=Q₁₀₀/Q₁×100(%)

The evaluation results are shown in Table 2 below.

TABLE 2

| | | | | rapid charge performance | |
|---|---|---|---|---|---|
| | initial performance | | | | capacity |
| | capacity | D_DCIR | C_DCIR | time | retention |
| | (mAh) | (mΩ) | (mΩ) | (min) | (100 cycles) |
| Example 1 | 21.4 | 4.38 | 4.52 | 24.2 | 95.5 |
| Example 2 | 21.4 | 4.26 | 4.34 | 23.6 | 93.3 |
| Example 3 | 21.4 | 4.32 | 4.41 | 22.7 | 95.7 |
| Example 4 | 21.4 | 4.28 | 4.37 | 23.7 | 94.5 |
| Comparative | 21.4 | 4.63 | 4.69 | 25.8 | 95.5 |
| Example 1 | | | | | |
| Comparative | 21.4 | 4.54 | 4.49 | 24.9 | 95.1 |
| Example 2 | | | | | |
| Comparative | 21.4 | 4.63 | 4.62 | 25.7 | 95.2 |
| Example 3 | | | | | |
| Comparative | 21.4 | 4.43 | 4.39 | 24.1 | 86.5 |
| Example 4 | | | | | |
| Comparative | 21.4 | 4.39 | 4.35 | 24.3 | 82.1 |
| Example 5 | | | | | |

Referring to Table 2, in Examples where EC, EMC and PP were all used as the organic solvent and the isothiazolidine-based additive was included, the initial resistance and the rapid charging time of the lithium secondary battery were reduced.

In Example 1 where only LiPF₆ was used as a lithium salt, the capacity retention was improved compared to that from Example 2 including both LiPF₆ and the sulfonyl imide-based lithium salt as the lithium salt, but the initial resistance and the rapid charge time were relatively increased.

In Example 3 where both LiPF₆ and the sulfonyl imide-based lithium salt were added as the lithium salt, the volume ratio of EMC in the organic solvent was increased, and the volume ratio of PP was lowered, the initial resistance and the rapid charging time were decreased and the capacity retention was increased compared to those from Example 2.

In Example 4 where a ratio of a molar concentration ratio of LiPF₆ to a molar concentration of the sulfonyl imide-based lithium salt was 2 or more, the capacity retention was improved compared to that from Example 2 where the molar concentration ratio was 1.5, but the initial resistance and the rapid charging time were relatively increased.

What is claimed is:

1. An electrolyte solution for a lithium secondary battery, comprising:
a lithium salt;
an organic solvent comprising a linear carbonate-based compound represented by Chemical Formula 1 and a linear ester-based compound represented by Chemical Formula 2; and
a compound represented by Chemical Formula 3: 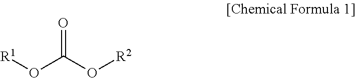
wherein, in Chemical Formula 1, R¹ and R² are each independently a C1-C6 alkyl group, and at least one of R¹ and R² is a methyl group, 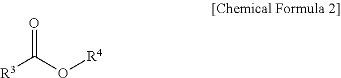
wherein, in Chemical Formula 2, R³ is a C1-C6 alkyl group, and R⁴ is a C3-C10 alkyl group, 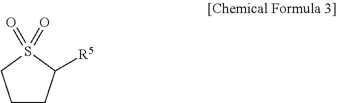
wherein, in Chemical Formula 3, R⁵ is a C1-C10 alkyl group, a C2-C10 alkenyl group, or a C2-C10 alkynyl group.

2. The electrolyte solution for a lithium secondary battery according to claim 1, wherein, in Chemical Formula 1, R¹ and R² are each independently a C1-C3 alkyl group, and at least one of R¹ and R² is a methyl group.

3. The electrolyte solution for a lithium secondary battery according to claim 1, wherein, in Chemical Formula 2, R³ is a C1-C3 alkyl group, and R⁴ is a C3-C6 alkyl group.

4. The electrolyte solution for a lithium secondary battery according to claim 1, wherein the organic solvent further comprises a cyclic carbonate-based compound represented by Chemical Formula 4: 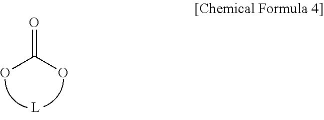
wherein, in Chemical Formula 4, L is a C2-C5 alkylene group or a C2-C5 alkenylene group.

5. The electrolyte solution for a lithium secondary battery according to claim 1, wherein the linear ester-based compound represented by Chemical Formula 2 is contained in an amount from 10 vol % to 30 vol % based on a total volume of the organic solvent.

6. The electrolyte solution for a lithium secondary battery according to claim 1, wherein, in Chemical Formula 3, R⁵ is a C2-C10 alkynyl group.

7. The electrolyte solution for a lithium secondary battery according to claim 1, wherein a content of the compound represented by Chemical Formula 3 is in a range from 0.1 wt % to 10 wt % based on a total weight of the electrolyte solution.

8. The electrolyte solution for a lithium secondary battery according to claim 1, wherein the lithium salt comprises LiPF₆.

9. The electrolyte solution for a lithium secondary battery according to claim 8, wherein the lithium salt further comprises a sulfonylimide-based lithium salt represented by Chemical Formula 5: 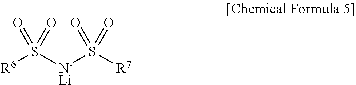
wherein, in Chemical Formula 5, R⁶ and R⁷ are each independently fluorine or a C1-C6 fluorine-containing alkyl group.

10. The electrolyte solution for a lithium secondary battery according to claim 9, wherein a ratio of a molar concentration of LiPF₆ relative to a molar concentration of the sulfonylimide-based lithium salt represented by Chemical Formula 5 in the electrolyte solution is in a range from 1 to 2.

11. The electrolyte solution for a lithium secondary battery according to claim 1, wherein the electrolyte solution for a lithium secondary battery further comprises an auxiliary additive including at least one selected from the group consisting of a fluorine-containing carbonate-based compound, a sultone-based compound, a cyclic sulfate-based compound and a fluorine-containing lithium phosphate-based compound.

12. The electrolyte solution for a lithium secondary battery according to claim 11, wherein a weight ratio of the auxiliary additive relative to the compound represented by Chemical Formula 3 in the electrolyte solution is in a range from 0.5 to 10.

13. A lithium secondary battery, comprising:
a cathode;
an anode facing the cathode; and
the electrolyte solution for a lithium secondary battery of claim 1.
